(19) United States
(12) Patent Application Publication
(10) Pub. No.: US 2013/0033849 A1
(43) Pub. Date: Feb. 7, 2013

(54) BACKLIGHT

(71) Applicants: Peter John ROBERTS, Oxford (GB); David James MONTGOMERY, Oxfordshire (GB)

(72) Inventors: Peter John ROBERTS, Oxford (GB); David James MONTGOMERY, Oxfordshire (GB)

(73) Assignee: SHARP KABUSHIKI KAISHA, Osaka (JP)

(21) Appl. No.: 13/204,128

(22) Filed: Aug. 5, 2011

(51) Int. Cl. F21V 13/04; G09F 13/04

(52) U.S. Cl. 362/97.1; 362/241

(57) ABSTRACT

A backlight is provided for an at least partially transmissive display or another lighting application. The backlight comprises an array of primary light sources that emit downwards towards an arrangement of curved mirror surfaces. The light reflected by the mirror surfaces is collimated by an arrangement of lenses. The mirror surface shape, lens shape, primary light source positions and the separation between the lens and mirror surfaces are chosen to ensure a high degree of spatial uniformity as well as collimation.

### TECHNICAL FIELD

The present invention relates to a backlight, for example for use with an at least partially transmissive spatial light modulator. The present invention also relates to a display including such a backlight. Moreover, the present invention relates to a distributed illumination panel that may be used for general illumination.

In particular, the invention relates to maintaining high spatial uniformity of a highly collimated direct view backlight with reduced thickness.

### BACKGROUND ART

FIG. 1(A) shows a conventional liquid crystal display (LCD) configuration in which collimated white light from the backlight 1 is focused, by means of a lens array 2, through apertures 3 within a thin film transistor (TFT) layer associated with the display electronics. The focusing prevents light being lost by absorption or scatter in the TFT electronics. A diffusing layer 5 is added above a liquid crystal (LC) cell 6, polarizers 7 and 7′ and the TFT layer. The function of the diffusing layer 5 is to increase the angular spread of light rays emitted from the device and so increase the angular range over which the display may be viewed. The properties of diffusing layer 5 are carefully chosen to minimize ambient light reflectance and image blurring yet produce sufficient angular spread. Each TFT aperture is associated with a color sub-pixel. Red (8R), green (8G) and blue (8B) color filters, each indexed to a TFT aperture, are used to produce the sub-pixel color from the white backlight. It will be understood that other sub-pixel color schemes, such as RGBY, are also possible.

FIG. 1(B) shows a conventional alternative LCD configuration that makes use of a collimated blue backlight 1′. In this scheme, the backlight light 1′ is focused by lens sheet 2 through the TFT apertures and into individual chambers 11R, 11G and 11B associated with red, green and blue sub-pixels, respectively. A red-emitting phosphor is housed in each chamber 11R, a green phosphor is each chamber 11G and diffusive material in each chamber 11B. The phosphors are chosen to give adequate absorption at the blue wavelength of the backlight. The chamber layer 11 is separated from the collimated backlight 1′ by the LC cell 6, polarizers 7 and 7′ and TFT layer with apertures 3. A color filter layer 8 is used to reduce ambient light reflectance from the display which would otherwise degrade image contrast. Focused light from a highly collimated backlight is particularly beneficial for this sort of display since the light must enter the chamber correctly indexed to the TFT aperture it passed through. If it enters an incorrectly addressed chamber, cross talk and consequent image degradation occurs. The blue backlight can be replaced by a UV backlight, in which case a blue emitting phosphor is housed in the chambers 11B instead of wavelength preserving scattering material. It will be understood that other sub-pixel color schemes are also possible.

The display types described above require highly collimated and spatially uniform backlights to adequately function. Lightguide-based backlights have the advantage of being thin and requiring relatively few primary light sources such as LEDs, but attaining highly collimated output with good light extraction efficiency and uniformity has proven difficult. Direct-view backlights, which do not involve side-injection of light into a lightguide, are commonly used in large area displays. This backlight form gives uniform output when used in conjunction with a strong diffuser layer. Any collimation is, however, necessarily lost after passing through such a diffuser. Direct view backlights are generally thicker than lightguide based ones but are more appropriate for applying local dimming techniques to improve efficiency. Even without local dimming, direct view backlights can give higher efficiency than lightguide ones, since the injection of light into a lightguide and the extraction of light from a lightguide are inherently lossy processes, particularly when uniformity is demanded.

Collimated output can be attained using a direct view backlight. FIG. 2 schematically shows a known backlight. FIG. 2(A) shows a 3-dimensional representation of the geometry and FIG. 2(B) a cross sectional view with example ray trajectories. The backlight includes a tiled array of single reflection light emitting diodes (SRLEDs). Each SRLED includes an LED 21 that emits downwards towards a parabolic mirror 22. The emitting surface of the LED is placed close to the focus of the parabolic mirror so that the reflected light is well collimated. The spatial uniformity in the light field reflected from the mirror is, however, poor, as will be illustrated by an example below.

The output irradiance distribution in a plane normal to the axis of a single SRLED is shown in FIG. 3(A) for the case of a downwards emitting point Lambertian light source located at the focus of a parabolic mirror. For this system, perfectly collimated light results from the mirror reflection (ignoring diffraction effects which are small for a mirror with a size many times the light wavelength). The reflectance at the mirror surface is assumed independent of the angle of incidence. The irradiance distribution, L(ρ), is purely a function the radial coordinate, ρ=(x²+y²)^{1/2}, measured from the central axis of the system. For the example system, the irradiance distribution is given analytically by

$$L ( ρ ) = \frac{2}{R} \frac{[ 1 - {( ρ / R )}^{2} ]}{{[ 1 + {( ρ / R )}^{2} ]}^{2}} \qquad ( 1 )$$

where R is the radius of curvature of the parabolic mirror at its central point (ρ=0). It is seen from FIG. 3 and Equ. (1) that the radiance drops off rapidly with radial distance from the system axis to reach zero at the radial coordinate ρ=R. Sample ray trajectories, obtained using a ray tracing algorithm, are shown in FIG. 3(B).

For the simple example model, the output irradiance distribution remains unchanged as a function of distance along the system axis due to the perfect collimation. A real SRLED will not give perfectly collimated light due to the finite extent of the emitting surface, imperfections in the mirror geometry, etc. The light irradiance distribution from a tiled array of such SRLEDs will therefore eventually become largely homogenized over an extended region after a sufficient propagation distance from the mirrors. It is essential that this homogenization has occurred at the position of the spatial light modulator in an LCD arrangement. The backlight collimation is such that large distances are required to achieve the homogenization. An SRLED array backlight has been constructed using SRLEDs each with cross-section dimensions of about 2 cm×2 cm measured in a plane normal to its axis. The light from each SRLED is collimated such that 80% of the output power is contained within a cone of half-angle 6° about the axial direction. It was found that significant spatial inhomogeneities remain in the light from the backlight even after 10 cm of propagation. This precludes use of the simple tiled SRLED array as a backlight in commercial LCDs due to stipulations on the maximum allowed thickness.

EP 0802443A1 (M. Ogino et al; published 22 Oct. 1997) describes a mirror and lens combination that can give collimated and spatially uniform light output. Some of the output light rays are transmitted through a lens without having impinged upon a mirror section. The remaining light rays reflect in a mirror section and may then pass through one or more lenses. The invention is most appropriate for light sources that emit approximately isotropic light.

GB 2385191A (J. Slack; published 13 Aug. 2003) describes a backlight that entails an array of single reflection light emitting diodes (SRLEDs) and a lens-based diffuser sheet. The SRLED array gives collimated but spatially non-uniform output. The diffuser sheet acts to spatially homogenize the output but the collimation is lost.

EP 02071640A1 (G. L. Abore; published 17 Jun. 2009) describes an array of side-emitting LEDs situated within mirror arrangements. The mirrors re-steer the light towards the output normal but only modest collimation is attained. The spatial uniformity of the light output is not addressed.

EP 02015126A1 (S. Bernard; published 14 Jan. 2009) describes a collimated backlight in which the angular distribution of light from a primary light source such as an LED is modified by a lens. A second lens is then used to collimate the light field emanating from this inner lens. The second lens is taken to be a Fresnel lens.

US07808581 (G. Panagotacos; published 5 Oct. 2010) describes a backlight that involves a deviator lens arrangement placed in front of a primary light source of small spatial extent. A total internal reflection (TIR) lens is used to collimate the output. One or more diffuser sheets are used to spatially homogenise the output but the collimation is then lost.

EP01762778A1 (M. Shinohara et. al.; published 14 Mar. 2007) describes, amongst other things, injection of collimated light from an array of SRLEDs into a lightguide. Light is then outcoupled from the lightguide by means of features placed on the lightguide. The lightguide is tapered to increase the outcoupling rate and aid attainment of spatial uniformity. The collimation and uniformity properties of this backlight are largely set by the lightguide and associated features rather than the output from the SRLED array.

In view of the aforementioned shortcomings associated with conventional backlights, there is a strong need in the art for a direct view backlight which maintains high spatial uniformity of a highly collimated light with reduced thickness.

### SUMMARY OF INVENTION

According to an aspect of the invention, a backlight is provided which includes an array of curved mirror sections; an array of primary light sources, the primary light sources arranged to illuminate a corresponding curved mirror section among the array of curved mirror sections; and a lens array positioned adjacent the array of primary light sources on a side opposite the array of curved mirror sections, wherein the curved mirror sections are shaped to reflect light from the corresponding primary light source so as to illuminate a corresponding lens within the lens array, and the lenses in the lens array are shaped to collimate the light reflected by the corresponding curved mirror sections.

According to another aspect, a radiant exitance at a plane immediately above the lens array varies by less than 50% over an area of the backlight.

According to yet another aspect, the light collimated by the lens array is such that more than 90% of the light power is contained within an angular cone with a half-width of 10 degrees.

In accordance with another aspect, a central axis of each curved mirror section coincides with a central axis of the corresponding lens and passes through the corresponding primary light source.

According to still another aspect, a light emission from each primary light source extends over a polar angular range, θ, relative to an outward normal from an emitting surface of the primary light source, and the outward normal is parallel to the central axes of the corresponding curved mirror section and primary light source.

In accordance with another aspect, a total angular spread of the light emission from each primary light source is restricted to the range 0°<θ<90° as measured in air.

According to yet another aspect, a lens cap is placed adjacent each of the primary light sources, the lens cap being configured to alter an emission angular profile of the primary light source to increase light radiance at higher values of θ.

In yet another aspect, the lens cap causes total internal reflection of light rays from the primary light source emitted close to a direction of the central axes of the corresponding curved mirror section and lens.

According to another aspect, a surface of each curved mirror section is deformed from being cylindrically symmetric about an axial direction.

In accordance with another aspect, where a central axis of each curved mirror section coincides with the z-axis of a Cartesian coordinate set and a sag of the surface of the curved mirror section is written z_{M}(x, y), a deviation of the surface of the curved mirror section from a parabolic form is represented by:

$$σ = {( \frac{{min}_{{z}_{P} , {R}_{P}} \{ \int {\int }_{mirror} d x d {y [ {z}_{M} ( x , y ) - {z}_{P} - ( {x}^{2} + {y}^{2} ) / ( 2 {R}_{P} ) ]}^{2} \}}{\int {\int }_{mirror} d x d {y [ {z}_{M} ( x , y ) - {z}_{P}^{( m i n )} ]}^{2}} )}^{1 / 2}$$

where the integrals are taken over an extent of the curved mirror section, parameters z_{P} and R_{P} represent the z-coordinate of the apex of the curved mirror section and the radius of curvature of the curved mirror section at its center, respectively, the integral in the numerator is minimized with respect to the parameters z_{P} and R_{P}, and the value z_{P}^{(min)} is the value of z_{P} when the numerator has been minimized.

According to another aspect, a value of σ is at least 0.05.

In accordance with still another aspect, a spatial extent of each primary light source, including packaging and necessary wiring, is less than a tenth of an aperture size of the corresponding lens within the lens array.

In yet still another aspect, the array of curved mirror surfaces, the array of primary light sources and the lens array are configured in tiled arrangement.

According to still another aspect, the array of curved mirror surfaces, the array of primary light sources and the lens array are configured in lenticular arrangement.

In accordance with another aspect, the lens array comprises an array of Fresnel lenses.

In still another aspect, a beam waist of light reflected by each curved mirror section is located between the curved mirror section and the corresponding lens within the lens array.

According to another aspect, each curved mirror section and corresponding primary light source and lens form an integrated unit.

According to still another aspect, each lens is directly connected to the corresponding curved mirror section, and the corresponding primary light source is embedded within a lens material making up the lens.

In accordance with still another aspect, a display is provided including a backlight as described herein.

According to still another aspect, an illumination panel is provided including a backlight as described herein.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

In the annexed drawings, like references indicate like parts or features:

FIG. 1 illustrates two conventional display forms that benefit from a highly collimated and spatially uniform backlight. FIG. 1(A) shows a form that utilizes a white backlight and FIG. 1(B) shows a form that utilizes a blue backlight.

FIG. 2 illustrates a backlight constructed from an array of single reflection light emitting diodes (SRLEDs). FIG. 2(A) shows a 3D representation and FIG. 2(B) shows a cross sectional view. FIG. 2(B) includes example light ray paths.

FIG. 3 illustrates the light output from an SRLED. FIG. 3(A) shows the irradiance distribution and FIG. 3(B) illustrates a sample of ray paths found using a ray tracing computer program.

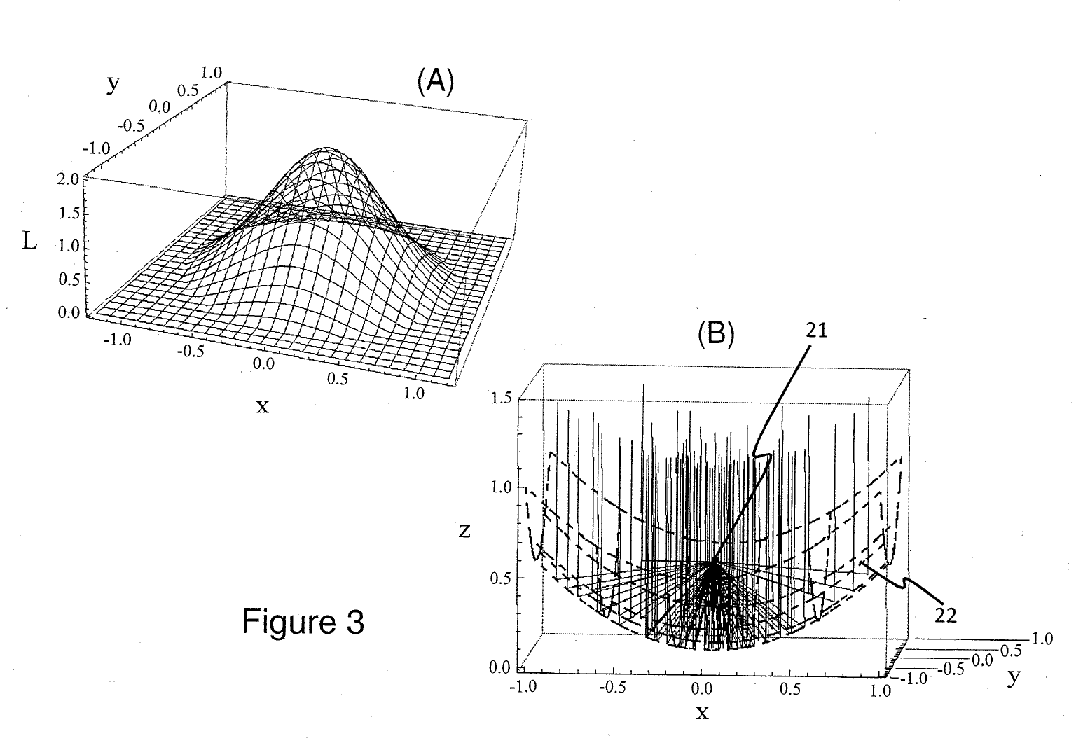

FIG. 4 illustrates the first embodiment of the invention. FIG. 4(A) shows a schematic representation in 3D and FIG. 4(B) shows a cross sectional view. FIG. 4(B) includes example light ray paths.

FIG. 5 illustrates the light output from an example of the first embodiment of the invention. FIG. 5(A) shows the output irradiance distribution from a single unit cell. FIG. 5(B) illustrates a sample of ray paths found using a ray tracing computer program. FIG. 5(C) shows the far field intensity distribution as a function of angle to the axial direction.

FIG. 6(A) and FIG. 6(B) illustrate two forms of a second embodiment of the invention.

FIG. 7 illustrates a third embodiment of the current invention.

FIG. 8 illustrates a fourth embodiment of the current invention.

FIG. 9 illustrates a fifth embodiment of the current invention.

FIG. 10 illustrates a lenticular variant of the invention.

FIG. 11 illustrates the action of active local dimming as provided by the main embodiments of the invention. FIG. 11(A) shows the backlight with a subset of the backlight units illuminated. FIG. 11(B) shows an example image that could be illuminated using the illumination pattern shown in FIG. 11(A).

### DESCRIPTION OF REFERENCE NUMERALS

1 refers to a spatially uniform collimated white-light backlight.
1′ refers to a spatially uniform collimated blue-light backlight.
2 refers to a collimating lens sheet.
3 refers to apertures in a TFT layer.
4 refers to a black mask array.
5 refers to a diffuser sheet.
6 refers to a liquid crystal cell.
7 refers to a polarizer.
7′ refers to a polarizer.
8 refers to color filter layer.
8R refers to a red filter in the color filter layer.
8G refers to a green filter in the color filter layer.
8B refers to a blue filter in the color filter layer.
11 refers to a layer containing phosphors
11R refers to a red emitting phosphor.
11G refers to a green emitting phosphor.
11B refers to a scattering medium.
21 refers to a primary light source.
21′ refers to an elongated primary light source.
22 refers to a parabolic mirror.
22′ refers to a non-parabolic mirror.
22″ refers to a lenticular mirror
25 refers to a collimating lens sheet.
25′ refers to a collimating Fresnel lens sheet.
25″ refers to a lenticular lens sheet.
31 refers to a refracting lens cap.
31′ refers to a lens cap that TIR reflects rays propagating close to the axial direction.
41 refers to a beam waist.
61 refers to a lens made of resin in which a light source 21 is embedded.
62 refers to adhesive material used to connect elements of a backlight.
71 refers to a backlight cell that has been illuminated.
72 refers to a backlight cell that has not been illuminated.

### DETAILED DESCRIPTION OF INVENTION

The present invention will now be described in detail with reference to the drawings, in which like reference numerals are used to refer to like elements throughout.

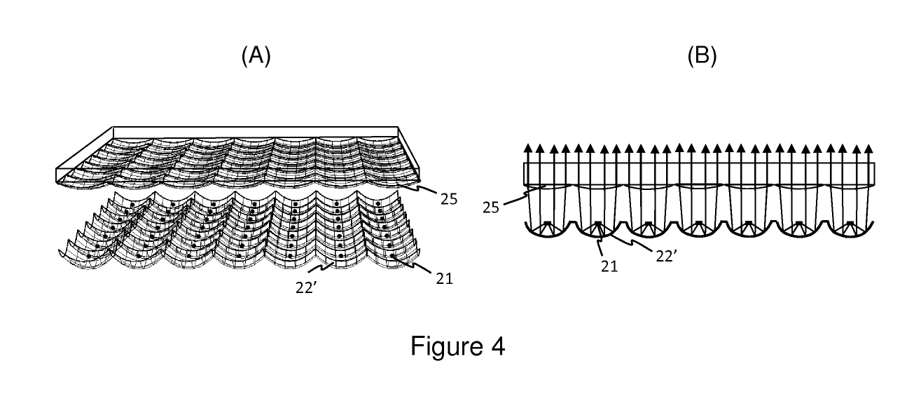

According to an aspect of the invention a backlight is provided which includes an array of curved mirror sections, each section of which is illuminated from above by an LED or other primary light source within an array of primary light sources. Also provided is a lens sheet that acts to collimate the light reflected from the mirror sections. The lens sheet is placed adjacent the array of primary light sources on a side opposite the array of curved mirror sections, or above the light sources and the mirror sections as shown in FIG. 4. The light reflected from each mirror section primarily enters the correctly addressed lens in the lens array. The central axis of each mirror section coincides with that of the correctly addressed lens and passes through the primary light source.

The mirror section shape, lens shape and light source positions are chosen to ensure spatial uniformity in the light output as well as collimation. Preferentially, the collimation is such that more than 90% of the light power is contained within an angular cone with a half-width of 10 degrees. Preferentially, the radiant exitance at a plane immediately above the lens array varies by less than 50% over the backlight area.

The spatial extent of the emitting surface of each primary light source is small in comparison to the aperture size of each lens in the array. This aspect is desirable in order to achieve collimation. Preferentially, the area of the emitting surface of each light source is less than one hundredth of that of each lens. It is also desirable for the spatial extent of the light source, including the packaging and any necessary wiring, is substantially smaller than that of each lens in the array. Preferentially, the maximum cross sectional area of each source including any packaging and wiring is less than a tenth of the aperture size of each lens in the array. Here, the cross-section is understood as being taken in the plane normal to the central axis of the mirror sections and lenses.

The light emission from each primary light source extends over a polar angular range, θ, relative to the outward normal from the emitting surface. This outward normal is preferentially parallel to the central axis of the mirror sections and lenses. Preferentially, the total angular spread of the emission from the light source is restricted to the range 0°<θ<90° as measured in air. This includes the emission profile of most forms of LED, which are approximately Lambertian in radiance within the range 0°<θ<90°. Isotropic light sources are not appropriate for the current invention.

In a preferred embodiment, the curved surface of each mirror section and lens is deformed from being cylindrically symmetric about an axial direction. The surface shapes are chosen so that the emission escaping from each lens in the array is uniform over the entire lens aperture. In this way, an extended uniform and collimated backlight can be realized from the array ensemble.

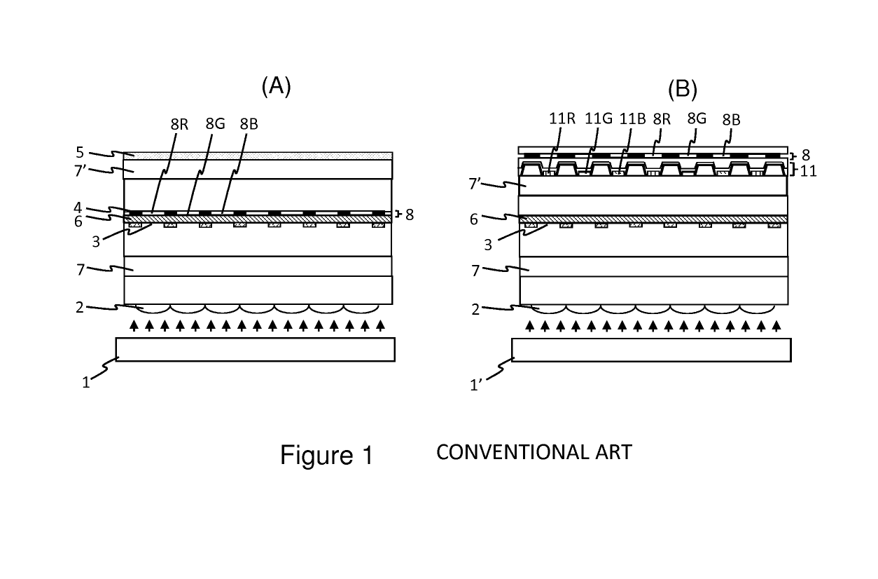

A highly collimated backlight is beneficial in liquid crystal displays (LCDs) since: 1) the light traversing the liquid crystal cell is close to being on-axis, thus improving contrast and color balance and 2) it enables light to be focused through thin film transistor (TFT) apertures so that device efficiency is improved. To ensure that the viewing angle range is sufficient for the application, it may be desirable to apply a diffuser sheer above the TFT, as shown in FIG. 1(A).

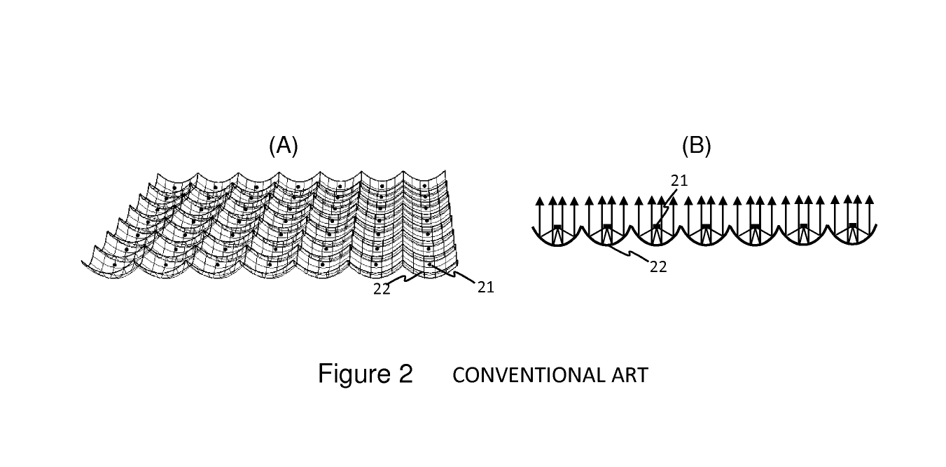

The present invention provides a means of attaining spatial uniformity with highly collimated output with a much reduced device thickness. FIG. 4 illustrates the first embodiment of the invention. FIG. 4(A) shows a 3-dimensional rendering of the geometry and 4(B) shows a cross-section including sample ray paths. In contrast to the backlight of FIG. 2, mirrors 22′ within the mirror array are not parabolic in shape and do not give collimated output after light from primary light sources 21 is reflected in them. A collimating lens sheet 25 made up of a lens array is used to collimate the light reflected by the mirror array. Each lens in the lens array is registered with a corresponding mirror 22′ in the mirror array. The mirror shape, lens shape, light source position and the separation between the mirror and lens sheet are carefully chosen to attain spatial uniformity as well as collimation in the light leaving the lens sheet 25.

The backlight includes a tiled array of single reflection light emitting diodes (SRLEDs) each serving as a respective light source. Each SRLED includes an LED 21 as a primary light source that emits downwards towards a corresponding mirror 22′ (also referred to herein as a “curved mirror section”). To attain a spatially extended uniform radiance from the SRLED plus lens sheet backlight, the output from each SRLED and lens (representing a “unit cell” in the array) should be uniform over the entire area of the unit cell. To achieve such uniform output requires the mirror 22′ and lens surface within the unit cell to not have cylindrical symmetry, that is to say, the sag of these surfaces are not purely a function of the radial distance ρ from the central axis.

The shape of each mirror 22′ differs significantly from the parabolic form used in prior art collimating SRLEDs. If the central axis of a mirror coincides with the z-axis of a Cartesian coordinate set, the sag of the mirror 22′ surface can be written z_{M}(x, y). The deviation of the mirror surface from a parabolic form can be quantified by

$$σ = {( \frac{{min}_{{z}_{P} , {R}_{P}} \{ \int {\int }_{mirror} d x d {y [ {z}_{M} ( x , y ) - {z}_{P} - ( {x}^{2} + {y}^{2} ) / ( 2 {R}_{P} ) ]}^{2} \}}{\int {\int }_{mirror} d x d {y [ {z}_{M} ( x , y ) - {z}_{P}^{( m i n )} ]}^{2}} )}^{1 / 2} \qquad ( 2 )$$

where the integrals are taken over the extent of the curved mirror. The parameters z_{P} and R_{P} represent the z-coordinate of the apex of the curved mirror and the radius of curvature of the mirror at its center, respectively. The integral in the numerator is minimized with respect to the parameters z_{P} and R_{P}. The value z_{P}^{(min)} appearing in the denominator integral is the value of z_{P} when the numerator has been minimized. Preferentially, the value of the dimensionless parameter σ is at least 0.05.

A simplified model can readily be constructed that gives improved uniformity compared to a standard SRLED. In this model, a goal of achieving uniform output over a disk region is set rather than over a region such as a square or hexagon which can be tiled to fill an entire plane. This disk fills as much of the lens aperture area as possible without overlapping the boundaries of the unit cell. The mirror curved surface and the lens curved surface are both modeled as symmetric bi-conic shapes so that their sag is purely a function of the radial coordinate ρ, being given by

$${z}_{j} ( ρ ) = {z}_{j}^{( 0 )} + \frac{{ρ}^{2} / {R}_{j}}{1 + \sqrt{1 - ( 1 + {K}_{j} ) {ρ}^{2} / {R}_{j}^{2}}} , j = M , L \qquad ( 3 )$$

Here, R_{M} (R_{L}) is the on-axis radius of curvature of the mirror (lens). The conic constant of the mirror (lens) surface is set by K_{M} (K_{L}). The distance z_{L}⁽⁰⁾−z_{M}⁽⁰⁾ sets the separation between the lens and mirror apexes. z_{M}⁽⁰⁾ can, without loss of generality, be set to zero. A trivial scale invariance allows all lengths to be expressed in units of one of the length parameters. The mirror on-axis curvature, R_{M}, will be chosen as the unit of length. The emitter will again be taken as a point-like Lambertian emitter directed towards the mirror sections and positioned along the central axis. The axial position of the emitter will be denoted zₑ. With the refractive index of the lens set, the model thus has five parameters (K_{M}, R_{L}, K_{L}, zₑ, z_{M}⁽⁰⁾). These can be varied in an attempt to find configurations that give uniform collimated output over a disk region. This can be achieved using an optimization procedure based on minimization of an appropriate cost function that is a function of: 1) a measure of spatial uniformity of light output over the emitting disk region, σ_{S}; 2) the angular spread in the light output, σ_{θ}; 3) the device efficiency η; 4) the emitting disk area, Aₑ. For each trial system, the radiance distribution exiting the lens layer can found using ray tracing. For the described model, it can also be found analytically if any light reflected from the lens interfaces is considered lost from the system.

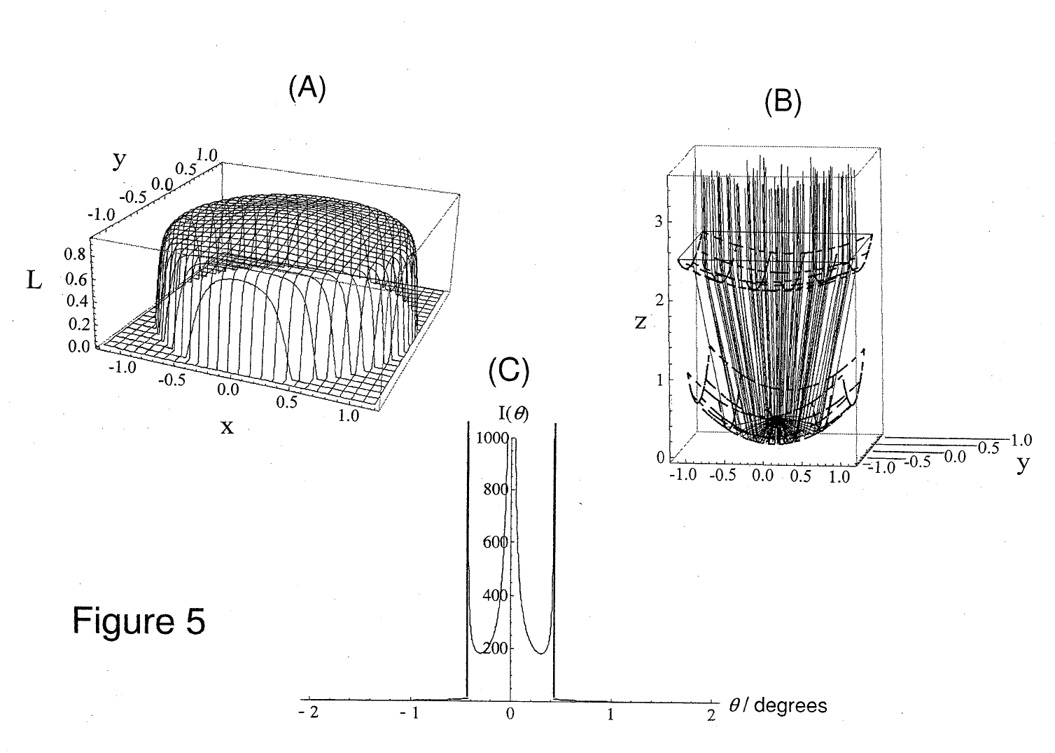

FIG. 5(A) shows the spatial irradiance distribution for an example configuration of the simple SRLED plus lens model. The irradiance is sampled in a plane just above the curved surface of the lens. The parameters are: K_{M}=−0.9, R_{L}=2.3R_{M}, K_{L}=−0.9, zₑ=0.35R_{M} and z_{M}⁽⁰⁾=2.4R_{M}. The refractive index of the lens is taken to be 1.5 and air exists between the mirror and lens. FIG. 5(B) shows a rendering of the system and shows sampled ray paths obtained using a ray tracing computer program. The angular dependence of the far-field intensity emitted from the system is shown in FIG. 5(C). The angular spread is seen to be less than +/−1° about the axial direction. The irradiance uniformity over the disk area is seen from FIG. 5(A) to be excellent. It is found that many sets of the parameters (K_{M}, R_{L}, K_{L}, zₑ, z_{M}⁽⁰⁾) can give sub +/−1° collimation with near perfect spatial uniformity over a disk region. It is to be remembered that the presented model employs a point source; the size of the emitting area of a real LED will impact the attainable collimation value.

It will be understood that the simplified example described above is for illustrative purposes and does not define the scope of the invention.

The near Lambertian output from an from a primary light source such as an LED is not ideal for forming a thin backlight with the mirror array and lens sheet.

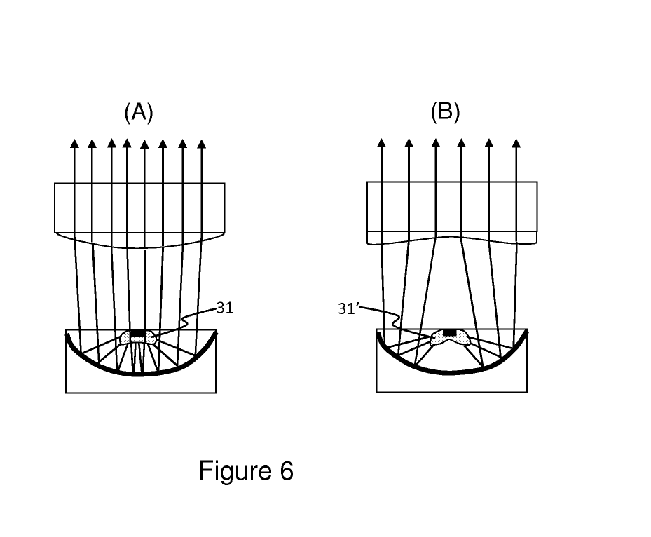

FIG. 6 shows a second embodiment where a lens cap 31 is placed over the LED to change the angular properties. Two configurations are shown. In the first, shown in FIG. 6(A), the lens cap 31 is purely refractive. More light is sent to higher angles from the axial direction than from the naked emitter. Specifically, the lens cap 31 alters the emission angular profile so that more light radiance is present at higher values of θ (but within the range 0°<θ<90° than would be from the naked primary light source. In this way, the backlight thickness can be made thinner. It also enables more of the light reflected from the mirror sections to be steered away from primary light sources thus improving the efficiency. The angular redistribution can also reduce stray light scatter at the primary light sources. If the backlight is used in a display, such stray scatter could cause degradation in image contrast. FIG. 6(B) shows a variation in which the lens cap 31′ causes total internal reflection of light rays emitted close to the axial direction of the mirror and lens. This can allow more light reflected at the mirrors to be steered away from the primary light sources. Both configurations enable more light to be prevented from impinging on the LED structure after reflection in the mirror. The form shown in FIG. 6(B) is particularly suited to steering light from the LED.

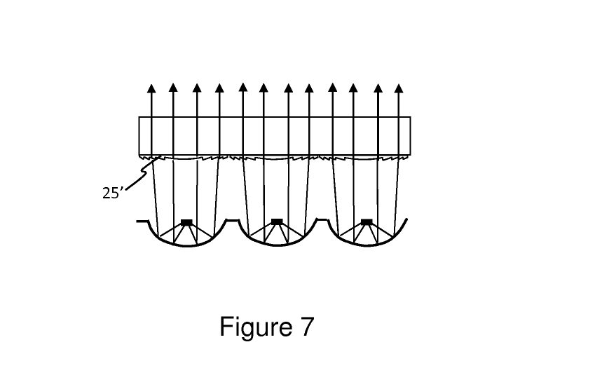

FIG. 7 shows a third embodiment in which the top lens sheet is replaced by an array of Fresnel lenses 25′. This enables a slightly thinner backlight to be realized and reduces the backlight weight. These are important design considerations in any mass produced display system.

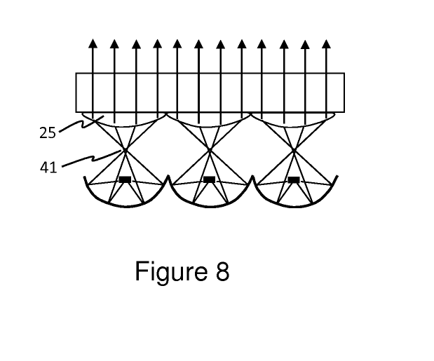

FIG. 8 shows a fourth embodiment in which each lens in the lens sheet 25 is placed above a beam waist 41 formed after reflection in the curved mirror. In other words, the beam waist 41 is located between the curved mirror and the corresponding lens in the lens array. Although this backlight form is thicker than other embodiments described herein, more configurations that give collimated and spatially uniform output can be found in this regime.

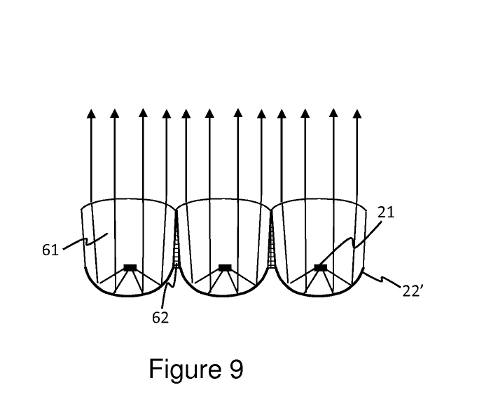

FIG. 9 shows a fifth embodiment in which the mirror 22′, lens and LED 21 form an integrated unit. The primary light source 21 is embedded within the lens material 61 that is formed from a resin or a suitable polymer and shaped as a lens. Each lens is directly connected to a curved mirror 22′ to make a single composite SRLED and lens unit. Preferentially, no air gaps exist between the lens resin 61 and the curved mirror 22′. The composite units may be connected using a suitable adhesive 62.

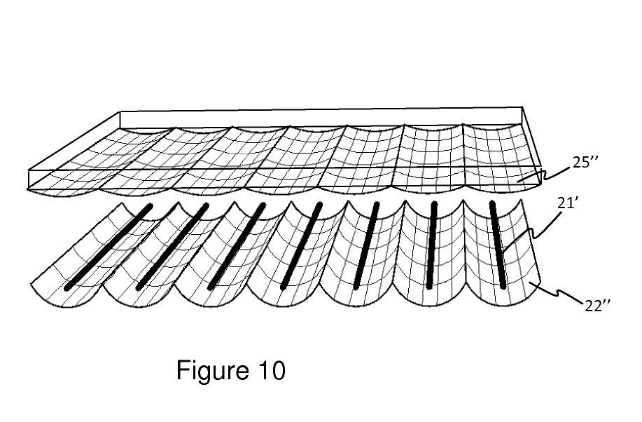

FIG. 10 shows an embodiment where each mirror and lens section is lenticular in comparison to the tiled arrangement of the embodiment of FIG. 4. In this embodiment, each primary light source 21′ is elongated and oriented with its long axis parallel to the lenticular axis. Each light source 21′ emits substantially into the downwards half space, i.e. towards a mirror section. This embodiment is the lenticular analogue of embodiment 1 shown in FIG. 4. It will be understood that the second thru fifth embodiments described above also have lenticular analogues.

The emission power and angular profile of a light source such as an LED shows some sample to sample variation. To attain the best backlight collimation and uniformity, it may be necessary to partition the light sources in relatively narrow power and angular emission profile bins prior to assembly of the backlight.

This is due to the inherent lack of mixing of light from different LEDs in this form of backlight. If sample to sample emission wavelength variations are sizeable, binning according to emission wavelength may also be required.

It may be possible to compensate for the emitter power variations by appropriately changing the driving power for each LED used. It is understood that narrow binning of the light sources and individual control of the driving power will significantly increase the cost of the backlight. As a cheaper alternative, the spatial profile of the transmittance of the spatial light modulator can be altered to compensate for the residual backlight brightness spatial variations.

The mirror and lens arrangements used in the invention can be fabricated by a variety of methods. A typical scale for a mirror section and lens in a unit cell of the backlight is of order a centimeter so that precision micro-optical fabrication is not required. The mirror arrangement can be made, for example, by metal evaporation coating a suitable substrate prepared with the required surface shapes. The substrate and lens surface relief can be fabricated using, for example, injection molding, blank molding, embossing or grinding. All the above fabrication procedures are known techniques. The mounting of the primary light sources should be accomplished using a connecting element that presents a small cross section to the light flow in the system. Likewise, the wiring that connects the primary light sources to the power source should be chosen to impart a small cross section to the light. Careful relative positioning of the backlight components is desirable to achieve good collimation and uniformity. In particular, alignment between the mirror and lens arrays should be maintained over the entire extent of the backlight.

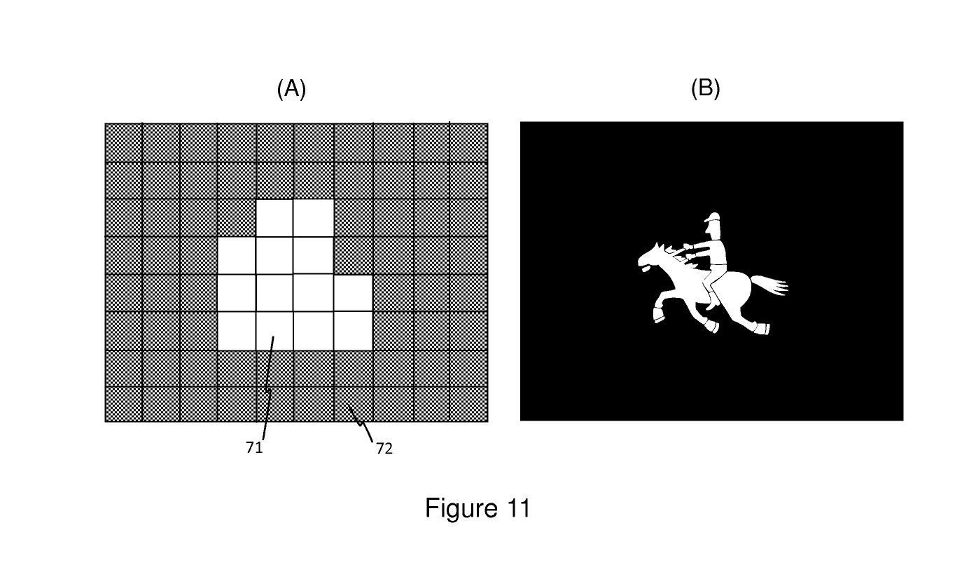

The disclosed invention allows active local dimming techniques to be applied over highly localized regions. This enables significant improvements in efficiency and also in the depth of the displayed black within an image. Each primary light source may be turned on or off depending on requirements set by the currently displayed image. Alternatively, to simplify the circuit wiring, blocks of the primary light sources may be electrically linked to turn on and off from a single electronic control setting. The power to each primary light source or block of light sources may be continuously variable to further enhance the active local dimming performance. FIG. 11(A) shows an example in which only a subset of the primary light sources has been switched on. The backlight is illuminated over a region defined by the corresponding cells 71 in the backlight array, the remaining cells 72 being dark. This pattern would be appropriate for backlighting the example image shown in FIG. 11(B).

Although described herein primarily in the context of serving as a backlight in an at least partially transmissive display, it will be appreciated that the backlight of the present invention may serve in many different lighting applications. For example, the backlight described herein may be used as a distributed illumination panel in general illumination applications. The present invention encompasses any and all such applications.

Although the invention has been shown and described with respect to a certain embodiment or embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

### INDUSTRIAL APPLICABILITY

The invention pertains to a backlight that can be used in high efficiency large area displays such as televisions and computer monitors. The invention relates to a form of direct view backlight with highly collimated and spatially uniform output. The backlight is thinner than prior art direct view collimated backlights that give spatially uniform radiance. The backlight enables local dimming techniques to be applied over highly localized regions, thus enabling substantial power saving. The backlight can be produced using established fabrication technologies. The invention can also be used in general lighting schemes where a spatially extended uniform and collimated light source is needed. An example application in this field is low-dazzle spotlights.

1. A backlight, comprising:
an array of curved mirror sections;
an array of primary light sources, the primary light sources arranged to illuminate a corresponding curved mirror section among the array of curved mirror sections; and
a lens array positioned adjacent the array of primary light sources on a side opposite the array of curved mirror sections,
wherein the curved mirror sections are shaped to reflect light from the corresponding primary light source so as to illuminate a corresponding lens within the lens array, and
the lenses in the lens array are shaped to collimate the light reflected by the corresponding curved mirror sections.

2. The backlight according to claim 1, wherein a radiant exitance at a plane immediately above the lens array varies by less than 50% over an area of the backlight.

3. The backlight according to claim 1, wherein the light collimated by the lens array is such that more than 90% of the light power is contained within an angular cone with a half-width of 10 degrees.

4. The backlight according to claim 1, wherein a central axis of each curved mirror section coincides with a central axis of the corresponding lens and passes through the corresponding primary light source.

5. The backlight according to claim 4, wherein a light emission from each primary light source extends over a polar angular range, θ, relative to an outward normal from an emitting surface of the primary light source, and wherein the outward normal is parallel to the central axes of the corresponding curved mirror section and primary light source.

6. The backlight according to claim 5, wherein a total angular spread of the light emission from each primary light source is restricted to the range 0°<θ<90° as measured in air.

7. The backlight according to claim 6, further comprising a lens cap placed adjacent each of the primary light sources, the lens cap being configured to alter an emission angular profile of the primary light source to increase light radiance at higher values of θ.

8. The backlight according to claim 7, wherein the lens cap causes total internal reflection of light rays from the primary light source emitted close to a direction of the central axes of the corresponding curved mirror section and lens.

9. The backlight according to claim 1, wherein a surface of each curved mirror section is deformed from being cylindrically symmetric about an axial direction.

10. The backlight according to claim 9, wherein where a central axis of each curved mirror section coincides with the z-axis of a Cartesian coordinate set and a sag of the surface of the curved mirror section is written z_{M}(x, y), a deviation of the surface of the curved mirror section from a parabolic form is represented by:
$$σ = {( \frac{{min}_{{z}_{P} , {R}_{P}} \{ \int {\int }_{mirror} d x d {y [ {z}_{M} ( x , y ) - {z}_{P} - ( {x}^{2} + {y}^{2} ) / ( 2 {R}_{P} ) ]}^{2} \}}{\int {\int }_{mirror} d x d {y [ {z}_{M} ( x , y ) - {z}_{P}^{( m i n )} ]}^{2}} )}^{1 / 2} \qquad ( 2 )$$
where the integrals are taken over an extent of the curved mirror section, parameters z_{P} and R_{P} represent the z-coordinate of the apex of the curved mirror section and the radius of curvature of the curved mirror section at its center, respectively, the integral in the numerator is minimized with respect to the parameters z_{P} and R_{P}, and the value z_{P}^{(min)} is the value of z_{P} when the numerator has been minimized.

11. The backlight according to claim 10, wherein a value of σ is at least 0.05.

12. The backlight according to claim 1, wherein a spatial extent of each primary light source, including packaging and necessary wiring, is less than a tenth of an aperture size of the corresponding lens within the lens array.

13. The backlight according to claim 1, wherein the array of curved mirror surfaces, the array of primary light sources and the lens array are configured in tiled arrangement.

14. The backlight according to claim 1, wherein the array of curved mirror surfaces, the array of primary light sources and the lens array are configured in lenticular arrangement.

15. The backlight according to claim 1, wherein the lens array comprises an array of Fresnel lenses.

16. The backlight according to claim 1, wherein a beam waist of light reflected by each curved mirror section is located between the curved mirror section and the corresponding lens within the lens array.

17. The backlight according to claim 1, wherein each curved mirror section and corresponding primary light source and lens form an integrated unit.

18. The backlight according to claim 17, wherein each lens is directly connected to the corresponding curved mirror section, and the corresponding primary light source is embedded within a lens material making up the lens.

19. A display comprising a backlight according to claim 1.

20. An illumination panel comprising a backlight according to claim 1.
